(19) United States
(12) Patent Application Publication
(10) Pub. No.: US 2004/0232666 A1
(43) Pub. Date: Nov. 25, 2004

(54) Side airbag apparatus

(75) Inventors: Yuji Sato, Aichi-ken (JP); Toshinori Tanase, Aichi-ken (JP)

Correspondence Address: POSZ & BETHARDS, PLC, 11250 ROGER BACON DRIVE, SUITE 10, RESTON, VA, 20190, US

(73) Assignee: TOYODA GOSEI CO., LTD.

(21) Appl. No.: 10/834,198

(22) Filed: Apr. 29, 2004

(30) Foreign Application Priority Data
May 8, 2003 (JP) 2003-130746

(51) Int. Cl. B60R 21/22

(52) U.S. Cl. 280/730.2

(57) ABSTRACT

A side airbag apparatus is mounted on a vehicle having a body and a seat on which an occupant is seated. The seat includes a seat section and a backrest section. A passenger compartment is defined in the body. The apparatus includes a first side airbag and a second side airbag. The first side airbag is deployed and inflated between the occupant and a sidewall of the passenger compartment to correspond to a body part of the occupant that includes a lumbar region. The second side airbag is deployed and inflated between the first side airbag and the sidewall of the passenger compartment to correspond to the lumbar region. Thus, when the airbags are deployed and inflated, the lumbar region of the occupant is pushed so that the entire body of the occupant is moved toward the center of the passenger compartment.

### BACKGROUND OF THE INVENTION

The present invention relates to a side airbag apparatus provided with a side airbag that is deployed and inflated between a sidewall of a passenger compartment of a vehicle and an occupant.

International Publication No. 02/100691 discloses a side airbag apparatus that protects an occupant from a collision to a side of a vehicle body. The side airbag apparatus includes a side airbag that has two chambers mutually partitioned, i.e., a lower chamber corresponding to a lumbar region of an occupant, and an upper chamber corresponding to a chest of the occupant. The lower chamber and the upper chamber are connected with each other through a passage. Gas is first supplied to the lower chamber from an inflator, and then, the gas is supplied to the upper chamber promptly.

When another vehicle collides with a side door of a vehicle provided with a side airbag apparatus, the door deforms toward the inside of a passenger compartment. In such a situation, the following features are required of the side airbag apparatus. A first feature, the side airbag apparatus is required to protect an occupant from the door that deforms toward the inside of the passenger compartment. Specifically, before the door deforms toward the inside of the passenger compartment, it is necessary to push an occupant's lumbar region by the airbag and to secure a space between the occupant and the door in the vehicle width direction in order to move the occupant sitting near the door toward the center of the passenger compartment. In addition, after the deformation of the door is started, it is necessary to prevent the door from colliding against the occupant by moving the occupant toward the center of the passenger compartment by the airbag as the door bulges into the passenger compartment, so as to maintain the space between the occupant and the door. On the other hand, as a second feature, the side airbag apparatus is required to lessen an impact applied to the occupant's chest, which has only the low resistance, as much as possible. In order to fully exhibit such two features, there is room for improvement in the side airbag apparatus disclosed in the above-mentioned International Publication No. 02/100691.

### SUMMARY OF THE INVENTION

Accordingly, it is an objective of the present invention to provide an improved side airbag apparatus that effectively protects an occupant in an appropriate manner according to the resistance of each of the body parts.

To achieve the foregoing and other objectives and in accordance with the purpose of the present invention, a side airbag apparatus mounted on a vehicle having a body and a seat on which an occupant is seated is provided. The seat includes a seat section and a backrest section. A passenger compartment is defined in the body. The apparatus includes a first side airbag and a second side airbag. The first side airbag is deployed and inflated between the occupant and a sidewall of the passenger compartment to correspond to a body part of the occupant that includes at least a lumbar region. The second side airbag is deployed and inflated between the first side airbag and the sidewall of the passenger compartment or between the first side airbag and the occupant to correspond at least to the lumbar region.

The present invention provides another side airbag apparatus mounted on a vehicle having a body and a seat on which an occupant is seated. The seat includes a seat section and a backrest section. A passenger compartment is defined in the body. The apparatus includes a firs side airbag and a second side airbag. The first side airbag is deployed and inflated between the occupant and a sidewall of the passenger compartment to correspond to a body part of the occupant that includes at least a shoulder. The second side airbag is deployed and inflated between the first side airbag and the sidewall of the passenger compartment or between the first side airbag and the occupant to correspond at least to the shoulder.

Further, the present invention provides another side airbag apparatus mounted on a vehicle having a body and a seat on which an occupant is seated. The seat includes a seat section and a backrest section. A passenger compartment is defined in the body. The apparatus includes a side airbag that is deployed and inflated between the occupant and a sidewall of the passenger compartment. The airbag includes a first inflation chamber and a second inflation chamber. The first inflation chamber corresponds to a body part of the occupant that includes at least a lumbar region. The second inflation chamber corresponds at least to the lumbar region between the first inflation chamber and the sidewall of the passenger compartment or between the first inflation chamber and the occupant.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1(a) is a schematic side view showing a side airbag apparatus according to a first embodiment of the present invention;

FIG. 1(b) is a schematic cross-sectional view taken along line 1b-1b in FIG. 1(a);

FIG. 2(a) is a schematic side view showing a side airbag apparatus according to a second embodiment of the present invention;

FIG. 2(b) is a schematic cross-sectional view taken along line 2b-2b in FIG. 2(a);

FIG. 3(a) is a schematic side view showing a side airbag apparatus according to a third embodiment of the present invention;

FIG. 3(b) is a schematic cross-sectional view taken along line 3b-3b in FIG. 3(a);

FIG. 4(a) is a schematic side view showing a side airbag apparatus according to a fourth embodiment of the present invention;

FIG. 4(b) is a schematic cross-sectional view taken along line 4b-4b in FIG. 4(a);

FIG. 5(a) is a schematic side view showing a side airbag apparatus according to a fifth embodiment of the present invention;

FIG. 5(b) is a schematic cross-sectional view taken along line 5b-5b in FIG. 5(a);

FIG. 6(a) is a schematic side view showing a side airbag apparatus according to a sixth embodiment of the present invention;

FIG. 6(b) is a schematic cross-sectional view taken along line 6b-6b in FIG. 6(a);

FIG. 7(a) is a schematic side view showing a side airbag apparatus according to a seventh embodiment of the present invention;

FIG. 7(b) is a schematic cross-sectional view taken along line 7b-7b in FIG. 7(a);

FIG. 8(a) is a schematic side view showing a side airbag apparatus according to an eighth embodiment of the present invention;

FIG. 8(b) is a schematic cross-sectional view taken along line 8b-8b in FIG. 8(a);

FIG. 9(a) is a schematic side view showing a side airbag apparatus according to a ninth embodiment of the present invention; and

FIG. 9(b) is a schematic cross-sectional view taken along line 9b-9b in FIG. 9(a).

### DETAILED DESCRIPTION OF THE PREFERRED EMBODIMENTS

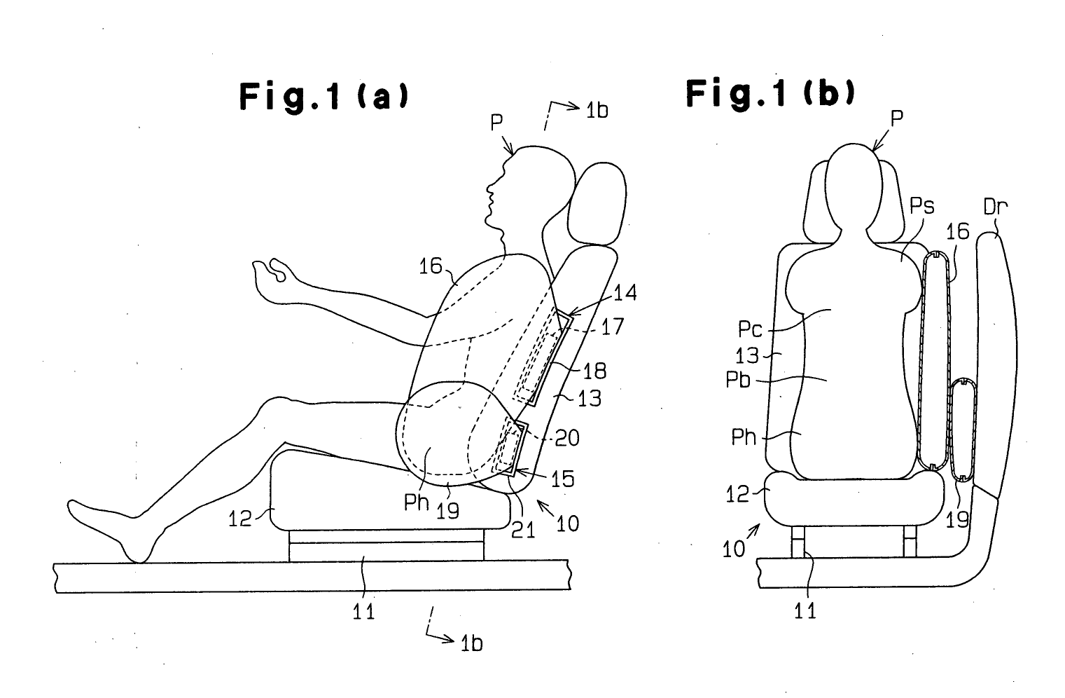

A first embodiment of the present invention will now be described with reference to FIGS. 1(a) and 1(b).

FIGS. 1(a) and 1(b) shows a front seat 10 of a vehicle that has a body. A passenger compartment is defined in the vehicle body. The front seat 10 includes a seat section 12 and a backrest section 13. The seat section 12 is fixed to a floor of the compartment with slide rails 11. The backrest section 13 is supported by the seat section 12. A first side airbag module 14 and a second side airbag module 15 are incorporated in a side of the backrest section 13 that is close to a side door Dr.

The first side airbag module 14 includes a first side airbag 16 and an inflator 17, which are accommodated in a case 18. The first side airbag 16 corresponds to a lumbar region Ph, an abdomen Pb, a chest Pc, and a shoulder Ps, which are body parts of an occupant P. The inflator 17 deploys and inflates the first side airbag 16. The first side airbag module 14 deploys and inflates the first side airbag 16 forward from a side the backrest section 13 with gas supplied from the inflator 17 such that the first side airbag 16 is located in a position corresponding to the lumbar region Ph, the abdomen Pb, the chest Pc, and the shoulder Ps between the occupant P and the door Dr. When the first side airbag 16 is deployed and inflated, the pressure in the first side airbag 16 is a predetermined first pressure.

The second side airbag module 15 includes a second side airbag 19 and an inflator 20, which are accommodated in a case 21. The second side airbag 19 corresponds to the lumbar region Ph of the occupant P. The inflator 20 deploys and inflates the second side airbag 19. The second side airbag module 15 deploys and inflates the second side airbag 19 forward from a side of the backrest section 13 with gas supplied from the inflator 20 such that the second side airbag 19 is located in a position corresponding to the lumbar region Ph of the occupant P between the first side airbag 16 and inner surface of the door Dr. When the second side airbag 19 is deployed and inflated, the pressure in the second airbag 19 is a predetermined second pressure that is higher than the first pressure.

An operation of the first embodiment will now be described.

For example, when another vehicle collides with the door Dr and the respective inflators 17 and 20 of the first side airbag module 14 and the second side airbag module 15 are actuated, the first side airbag 16 and the second side airbag 19 are deployed and inflated, respectively. On the basis of the detection result of a common impact sensor, the first side airbag module 14 and the second side airbag module 15 are controlled such that the modules 14, 15 are actuated either simultaneously or separately so that one of the modules 14, 15 is actuated after the other one of the modules 14, 15 at a delay of predetermined period.

When the first side airbag 16, which is deployed and inflated at the first pressure, and the second side airbag 19, which is deployed and inflated at the second pressure, fill a space between the lumbar region Ph of the occupant P and the inner surface of the door Dr, the airbags 16, 19 are arranged along the vehicle width direction. In this state, the airbags 16, 19 push the lumbar region Ph of the occupant P sitting by the door Dr, thereby moving the entire body of the occupant P toward the center of the passenger compartment. Therefore, even if the occupant P is seated close to the door Dr at the time of a collision, a space greater than a predetermined distance is secured between the occupant P and inner surface of the door Dr before the door Dr bulges into the passenger compartment.

In addition, as the door Dr is deformed by a side collision of another vehicle and bulges into the passenger compartment, the lumbar region Ph of the occupant P is pushed so that the entire body of the occupant P is moved toward the center of the passenger compartment. Accordingly, the space between the occupant P and inner surface of the door Dr is maintained so that the distance in the vehicle width direction is maintained to be longer than the predetermined length. Therefore, even if the door Dr is deformed and bulges into the passenger compartment, the door Dr is prevented from colliding with the occupant P.

In addition, the lumbar region Ph of the occupant P is pushed toward the center of the passenger compartment before and during the bulging of the door Dr, the second side airbag 19, which is deployed and inflated at the second pressure lower than the first pressure, absorbs an impact applied to the lumbar region Ph of the occupant P due to deployment and inflation of the first side airbag 16 or bulging of the door Dr. Therefore, before and during bulging of the door Dr, the occupant P is moved toward the center of the passenger compartment, while the impact applied to the lumbar region Ph is absorbed.

Furthermore, the second side airbag 19 absorbs impact that is applied to the abdomen Pb, the chest Pc, and the shoulder Ps of the occupant P as the door Dr bulges inward. Therefore, impact applied to the abdomen Pb, the chest Pc, and the shoulder Ps of the occupant P before and during inward bulging of the door Dr.

The above embodiment provides the following advantages.

(1) The first side airbag 16, which correspond to the lumbar region Ph, the abdomen Pb, the chest Pc, and the shoulder Ps (body parts of the occupant P), and the second side airbag 19, which corresponds to the lumbar region Ph between the first side airbag 16 and the door Dr, are deployed and inflated while being arranged along vehicle width direction. Then, the airbags 16, 19 move the occupant P toward the center of the passenger compartment by pushing the lumbar region Ph, the resistance of which is high. On the other hand, the first side airbag 16 absorbs the impact applied to the abdomen Pb and the chest Pc, resistance of which is low. Therefore, the occupant P is effectively protected in an appropriate manner according to the resistance of each of the body parts.

(2) The first side airbag 16, which is deployed and inflated at the predetermined first pressure, and the second side airbag 19, which is deployed and inflated at the predetermined second pressure higher than the first pressure, move the occupant P toward the center of the passenger compartment by pushing the lumbar region Ph. On the other hand, the first side airbag 16 absorbs the impacts applied to the abdomen Pb and the chest Pc. Therefore, it is possible to absorb the impacts applied to the occupant P due to deployment and inflation of the first side airbag 16 and the second side airbag 19, while moving the occupant P toward the center of the passenger compartment.

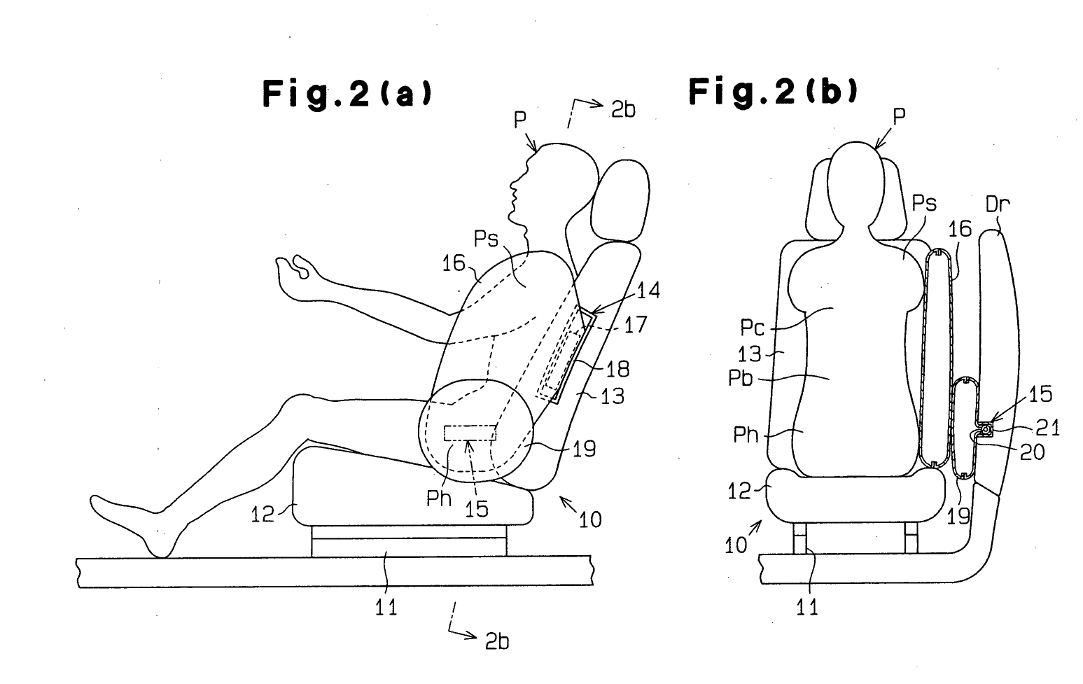

A second embodiment according to the present invention will be now described with reference to FIGS. 2(a) and 2(b). The second embodiment is different from the first embodiment only in the position of the second side airbag module 15.

As shown in FIGS. 2(a) and 2(b), the second side airbag module 15 in the second embodiment is provided in the inside of the door Dr. The second side airbag module 15 deploys and inflates the second side airbag 19 into the passenger compartment from the inside of the door Dr such that the second side airbag 19 is located in a position corresponding to the lumbar region Ph of the occupant P between the first side airbag 16 and the door Dr.

The second embodiment has the same advantages as the first embodiment.

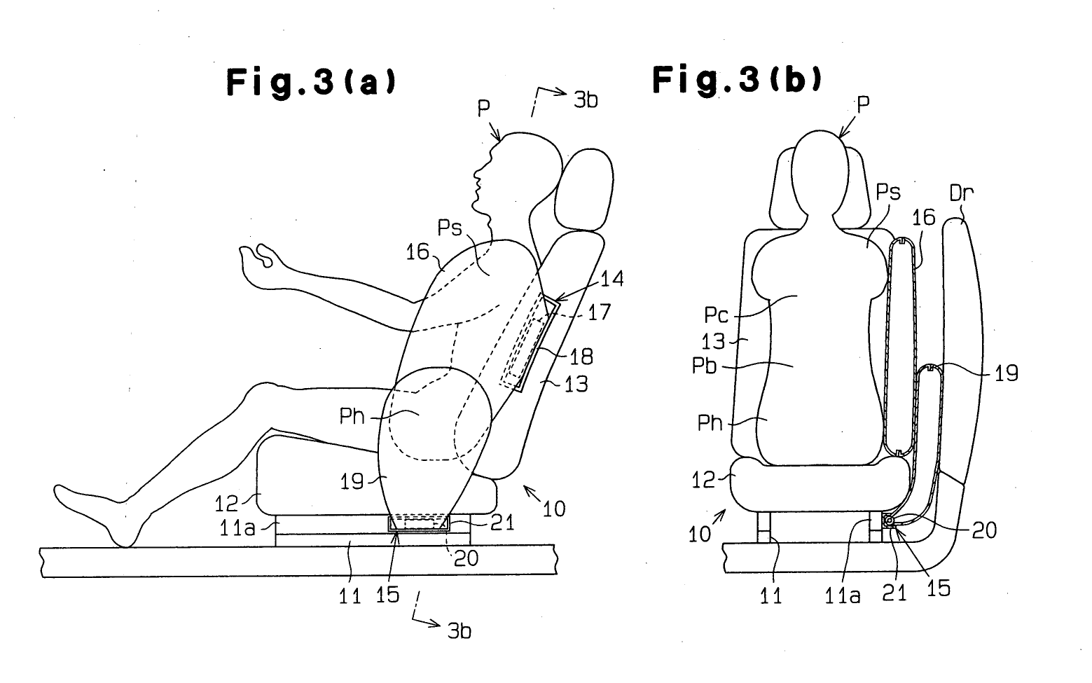

A third embodiment according to the present invention will now be described with reference to FIGS. 3(a) and 3(b). The third embodiment is different from the first embodiment only in the position of the second side airbag module 15.

As shown in FIGS. 3(a) and 3(b), the second side airbag module 15 in the third embodiment is provided in the side of the outer one of seat rails 11a fixed to the seat section 12. The second side airbag module 15 deploys and inflates the second side airbag 19 upward along the inner surface of the door Dr from below the seat section 12 such that the second side airbag 19 is located in a position corresponding to the lumbar region Ph of the occupant P between the first side airbag 16 and the door Dr.

The third embodiment has the same advantages as the first embodiment.

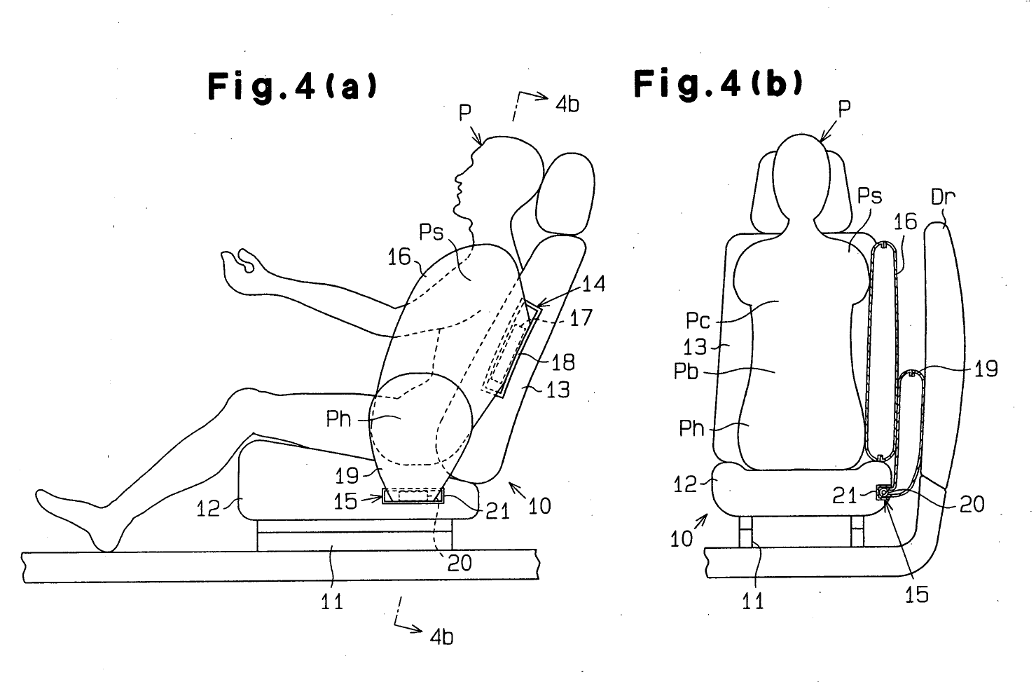

A fourth embodiment according to the present invention will now be described with reference to FIGS. 4(a) and 4(b). The fourth embodiment is different from the first embodiment only in the position of the second side airbag module 15.

As shown in FIGS. 4(a) and 4(b), the second side airbag module 15 in the fourth embodiment is provided in the seat section 12. The second side airbag module 15 deploys and inflates the second side airbag 19 upward along the inner surface of the door Dr from the side of the seat section 12 such that the second side airbag 19 is located in a position corresponding to the lumbar region Ph of the occupant P between the first side airbag 16 and the door Dr.

The fourth embodiment has the same advantages as the first embodiment.

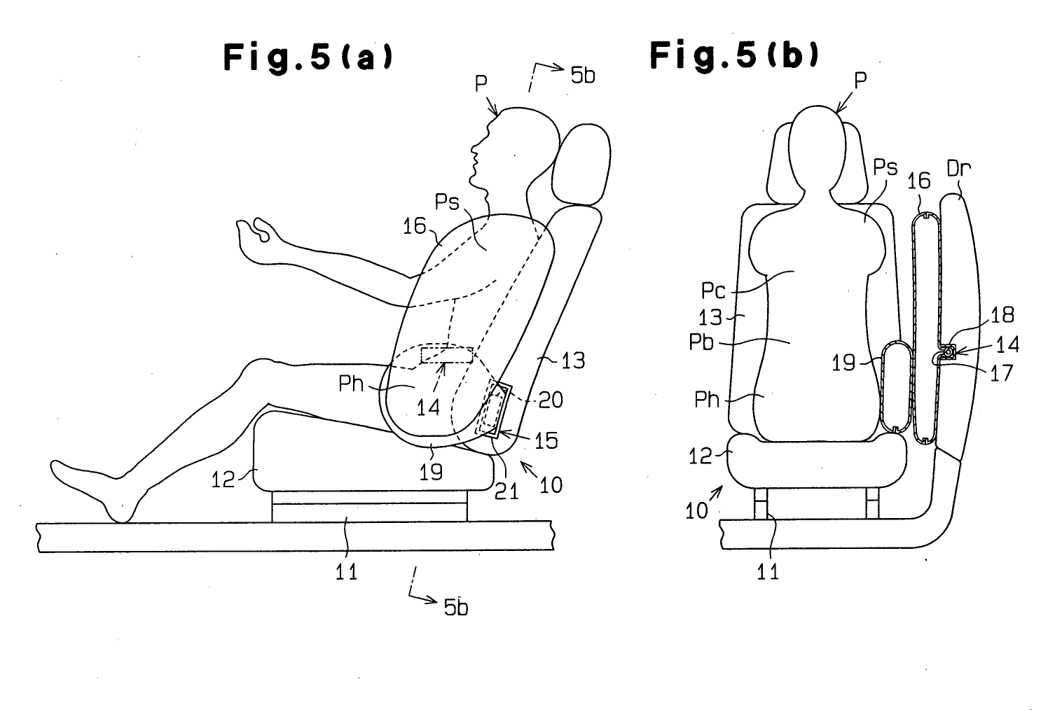

A fifth embodiment according to the present invention will now be described with reference to FIGS. 5(a) and 5(b). The fifth embodiment is different from the second embodiment in that the arrangement of the first side airbag module 14 and the second side airbag module 15 is reverse, and the arrangement of the first side airbag 16 and the second side airbag 19 is also reverse.

As shown in FIGS. 5(a) and 5(b), the first side airbag module 14 in the fifth embodiment is provided in the door Dr. The first side airbag module 14 deploys and inflates the first side airbag 16 to the interior of the passenger compartment from the inside of the door Dr such that the first side airbag 16 is located in a position corresponding to the lumbar region Ph, abdomen Pb, the chest Pc, and the shoulder Ps between the occupant P and the door Dr.

In addition, the second side airbag module 15 is incorporated in the backrest section 13. The second side airbag module 15 deploys and inflates the second side airbag 19 forward from a side of the backrest section 13 such that the second side airbag 19 is located in a position corresponding to the lumbar region Ph of the occupant P between the first side airbag 16 and inner surface of the door Dr. That is, the positional relationship of the first side airbag 16 and the second side airbag 19 in the vehicle width direction in the fifth embodiment is reverse to that in the second embodiment.

The fifth embodiment has the same advantages as the first embodiment.

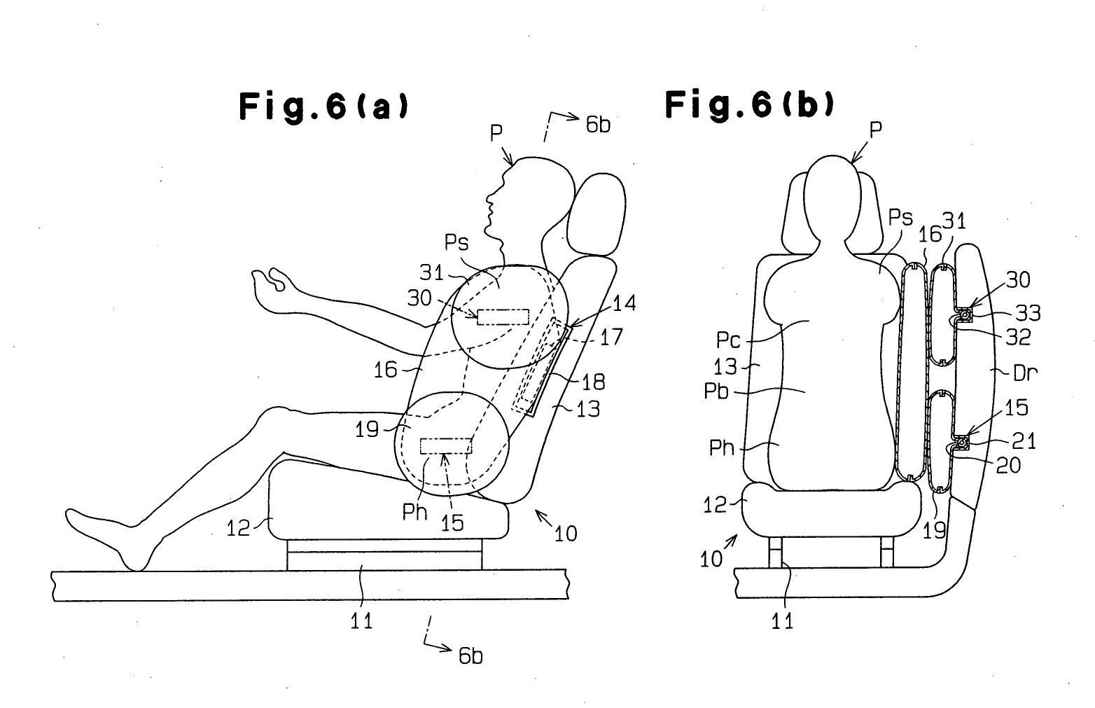

A sixth embodiment according to the present invention will now be described with reference to FIGS. 6(a) and 6(b). Since the sixth embodiment is the same as the second embodiment except that a third side airbag module 30 is added, the third airbag module 30 will be explained in full detail.

As shown in FIGS. 6(a) and 6(b), the third side airbag module 30 includes a third side airbag 31 and an inflator 32, which are accommodated in a case 33. The third side airbag 31 corresponds to the shoulder Ps of the occupant P. The inflator 32 deploys and inflates the third side airbag 31. The third side airbag module 30 deploys and inflates the third side airbag 31 into the passenger compartment from the inside of the door Dr with gas supplied from the inflator 32 such that the third side airbag 31 is located in a position corresponding to the shoulder Ps of the occupant P between the first side airbag 16 and the door Dr. When the third side airbag 31 is deployed and inflated, the pressure in the third side airbag 31 is the second pressure.

In addition to the first embodiment, the sixth embodiment operates in the following manner.

When the respective side airbags 16, 19, and 31 are deployed and inflated, the first side airbag 16, which is deployed and inflated at the first pressure, and the third side airbag 31, which is deployed and inflated at the second pressure, fill a space between the shoulder Ps of the occupant P and the inner surface of the door Dr, while being arranged along the vehicle width direction. In this state, the first and third airbags 16, 31 push the shoulder Ps of the occupant P sitting by the door Dr, thereby moving the entire body of the occupant P toward the center of the passenger compartment. Therefore, even if the occupant P is seated close to the door Dr at the time of a collision, a space greater than a predetermined distance is readily secured between the occupant P and inner surface of the door Dr before the door Dr bulges into the passenger compartment.

In addition, as the door Dr is deformed by a side collision of another vehicle and bulges into the passenger compartment, the lumbar region Ph and the shoulder Ps of the occupant P are pushed so that the entire body of the occupant P is moved toward the center of the passenger compartment. Accordingly, the space between the occupant P and inner surface of the door Dr is maintained so that the distance in the vehicle width direction is maintained to be longer than the predetermined length. Therefore, even if the door Dr is deformed and bulges into the passenger compartment, the door Dr is prevented from colliding with the occupant P.

Accordingly, in addition to the advantages (1) and (2) of the first embodiment, the sixth embodiment has the following advantages.

(3) The first side airbag 16, which is deployed and inflated according to body parts including the shoulder Ps, and the third side airbag 31, which is deployed and inflated corresponding to the shoulder Ps between the first side airbag 16 and door Dr, push the shoulder Ps having a high resistance, and move the occupant P toward the center of the passenger compartment. Therefore, since the shoulder Ps, as well as the lumbar region Ph, is pushed, it is possible to move the occupant P more reliably toward the center of the passenger compartment.

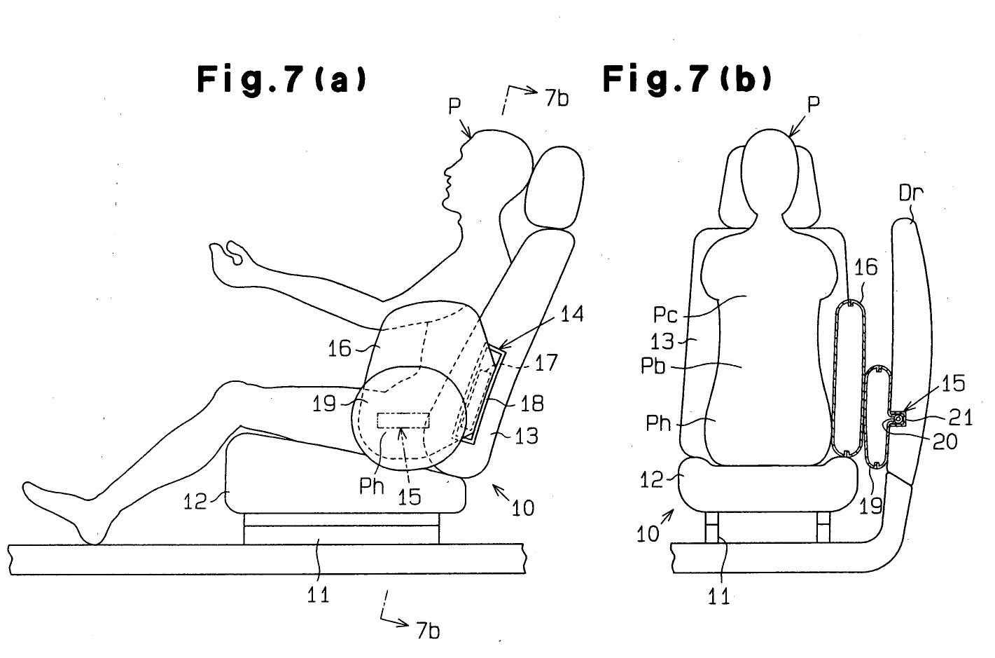

A seventh embodiment according to the present invention will now be described with reference to FIGS. 7(a) and 7(b). The seventh embodiment is different from the second embodiment only in the shape of the first side airbag 16.

As shown in FIGS. 7(a) and 7(b), the first side airbag 16 in the seventh embodiment corresponds to the lumbar portion Ph, the abdomen Pb, and the chest Pc of the occupant P. The first side airbag module 14 deploys and inflates the first side airbag 16 forward from a side of the backrest section 13 such that the first side airbag 16 is located in a position corresponding to the lumbar region Ph, the abdomen Pb, and the chest Pc of the occupant P between the occupant P and the door Dr.

The seventh embodiment has the same advantages as the second embodiment.

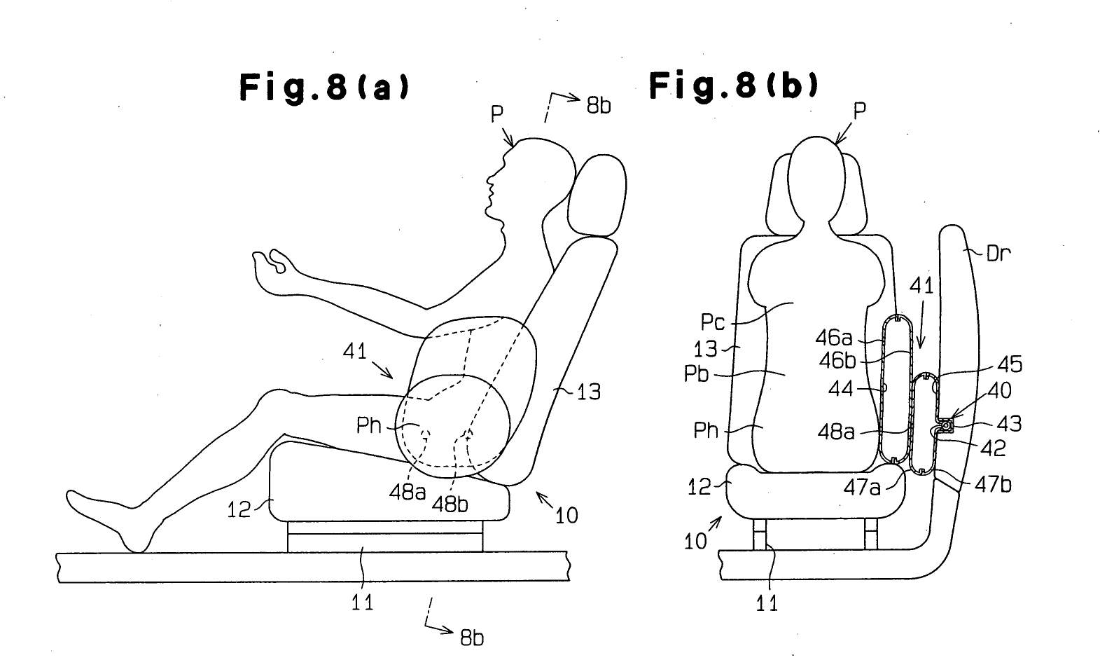

An eighth embodiment according to the present invention will now be described with reference to FIGS. 8(a) and 8(b). The eighth embodiment is the same as the first embodiment except that the first side airbag module 14 and the second side airbag module 15 are replaced by a single side airbag module 40. Thus, only the side airbag module 40 will be explained in full detail.

As shown in FIGS. 8(a) and 8(b), the side airbag module 40 is incorporated in the door Dr, and includes a side airbag 41 and an inflator 42, which are accommodated in a case 43. The side airbag 41 corresponds to the lumbar region Ph, the abdomen Pb, and the chest Pc, which are body parts of the occupant P. The inflator 42 deploys and inflates the side airbag 41.

The side airbag 41 includes a first inflation chamber 44 corresponding to the lumbar region Ph, the abdomen Pb, and the chest Pc of the occupant P, and a second inflation chamber 45 corresponding to the lumbar region Ph of the occupant P. The first inflation chamber 44 is formed by sewing a pair of fabric sheets 46a and 46b. The second inflation chamber 45 is also formed by sewing a pair of fabric sheets 47a and 47b. Then, the side airbag 41 is formed by sticking the first inflation chamber 44 and the second inflation chamber 45.

The inflator 42 supplies gas to the second inflation chamber 45. The gas supplied to the second inflation chamber 45 is supplied to the first inflation chamber 44 through vent holes 48a and 48b that connect the first inflation chamber 44 with the second inflation chamber 45.

The side airbag module 40 deploys and inflates the side airbag 41 into the passenger compartment from the inside of the door Dr. Accordingly, the first inflation chamber 44 is located in a position corresponding to the lumbar region Ph, the abdomen Pb, and the chest Pc between the occupant P and the door Dr. At the same time, the second inflation chamber 45 is located in a position corresponding to the lumbar region Ph between the first inflation chamber 44 and the door Dr. The deployment and the inflation of the inflation chambers 44, 45, the flow rate of the gas supplied to the first inflation chamber 44 from the second inflation chamber 45 is adjusted by the vent holes 48a and 48b, such that the pressure in the first inflation chamber 44 is the first pressure, and the pressure in the second inflation chamber 45 is the second pressure.

The eighth embodiment has the same advantages as the first embodiment.

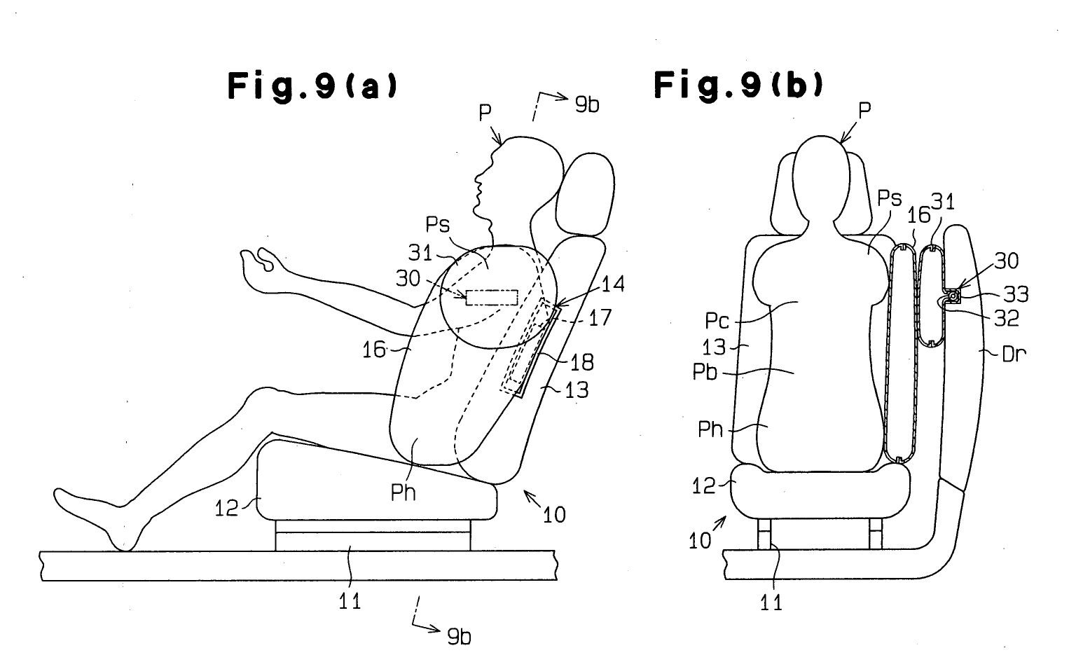

A ninth embodiment according to the present invention will now be described with reference to FIGS. 9(a) and 9(b). The ninth embodiment is the same as the sixth embodiment except that the second side airbag module 15 is omitted.

As shown in FIGS. 9(a) and 9(b), the ninth embodiment includes the first side airbag module 14 and third airbag module 30. Hereinafter, a description will be given on the assumption that the third side airbag module 30 functions as a second side airbag module, and the third side airbag 31 of the third airbag module 30 functions as a second airbag.

The ninth embodiment operates as follows.

When the first side airbag 16, which is deployed and inflated at the first pressure, and the second side airbag 31, which is deployed and inflated at the second pressure, fill a space between the shoulder Ps of the occupant P and the inner surface of the door Dr, the airbags 16, 31 are arranged along the vehicle width direction. In this state, the airbags 16, 31 push the shoulder Ps of the occupant P sitting by the door Dr, thereby moving the entire body of the occupant P toward the center of the passenger compartment.

In addition, as the door Dr is deformed by a side collision of another vehicle and bulges into the passenger compartment, the shoulder Ps of the occupant P is pushed so that the entire body of the occupant P is moved toward the center of the passenger compartment. Accordingly, the space between the occupant P and the door Dr is maintained so that the distance in the vehicle width direction is maintained to be longer than the predetermined length.

The above illustrated embodiment may be modified as follows.

In the first to fifth embodiments, the second side airbag 19 may be shaped to correspond to only the lumbar region Ph of the occupant P. That is, the first side airbag module 14 and the second side airbag module 15 push only the lumbar region Ph of the occupant P.

In the first embodiment, the second side airbag 19 may be deployed and inflated between the first side airbag 16 and occupant P.

In the third embodiment, the first side airbag module 14 may be provided in the outer one of the seat rails 11a, and the second side airbag module 15 may be provided in the backrest section 13. Furthermore, the second side airbag 19 may be deployed and inflated between the occupant P and first side airbag 16.

In the fourth embodiment, the first side airbag module 14 may be provided in the seat section 12, and the second side airbag module 15 may be provided in the backrest section 13. Furthermore, the second side airbag 19 may be deployed and inflated between the occupant P and first side airbag 16.

In the first embodiment, gas may be supplied from one inflator concurrently to the respective side airbags 16 and 19.

In the first to seventh embodiments, an internal pressure at the time when the first side airbag 16 is deployed and inflated may be substantially equal to an internal pressure at the time when the second side airbag 19 is deployed and inflated.

Furthermore, in the sixth embodiment, an internal pressure at the time when the third side airbag 31 is deployed and inflated may be substantially equal to an internal pressure of the first side airbag 16.

In the eighth embodiment, an internal pressure at the time when the first inflation chamber 44 is deployed and inflated may be substantially equal to an internal pressure at the time when the second inflation chamber 45 is deployed and inflated.

In the ninth embodiment, an internal pressure at the time when the third side airbag 31 is deployed and inflated may be substantially equal to an internal pressure of the first side airbag 16.

In the eighth embodiment, the first inflation chamber 44 and the second inflation chamber 45 may be separate from each other, and gas may be simultaneously supplied to the respective inflation chambers 44 and 45.

In the illustrated embodiments, one or more side airbags may be provided such that the additional airbags are arranged along the arrangement direction of the first side airbag 16 and the second side airbag 19.

A seat to which the present invention is applied is not limited to a front seat, behind which a back seat is provided. However, the present invention may be applied to a seat of a single row or to a back seat, in front of which a seat is provided.

Therefore, the present examples and embodiments are to be considered as illustrative and not restrictive and the invention is not to be limited to the details given herein, but may be modified within the scope and equivalence of the appended claims.

1. A side airbag apparatus mounted on a vehicle having a body and a seat on which an occupant is seated, wherein the seat includes a seat section and a backrest section, a passenger compartment is defined in the body, the apparatus comprising:
a first side airbag, wherein the first side airbag is deployed and inflated between the occupant and a sidewall of the passenger compartment to correspond to a body part of the occupant that includes at least a lumbar region; and
a second side airbag, wherein the second side airbag is deployed and inflated between the first side airbag and the sidewall of the passenger compartment or between the first side airbag and the occupant to correspond at least to the lumbar region.

2. The side airbag apparatus according to claim 1, wherein the first side airbag is deployed and inflated such that the pressure of the first side airbag becomes a predetermined first pressure, and the second side airbag is deployed and inflated such that the pressure of the second side airbag becomes a predetermined second pressure, the second pressure being higher than the first pressure.

3. The side airbag apparatus according to claim 1, wherein the first side airbag is deployed and inflated to correspond also to a shoulder of the occupant.

4. The side airbag apparatus according to claim 3, wherein, before being deployed and inflated, the first and second airbags are accommodated in the backrest section.

5. The side airbag apparatus according to claim 3, wherein, before being deployed and inflated, the first airbag is accommodated in the backrest section, and the second airbag is accommodated in a side door of the vehicle.

6. The side airbag apparatus according to claim 3, wherein, before being deployed and inflated, the first airbag is accommodated in the backrest section, and the second airbag is accommodated in a rail that supports the seat section on the body of the vehicle.

7. The side airbag apparatus according to claim 3, wherein, before being deployed and inflated, the first airbag is accommodated in the backrest section, and the second airbag is accommodated in the seat section.

8. The side airbag apparatus according to claim 3, wherein, before being deployed and inflated, the first airbag is accommodated in the a side door of the vehicle, and the second airbag is accommodated in the backrest section.

9. The side airbag apparatus according to claim 3, further comprising a third side airbag, wherein the third side airbag is deployed and inflated between the first side airbag and the sidewall of the passenger compartment or between the first side airbag and the occupant to correspond to a shoulder of the occupant.

10. The side airbag apparatus according to claim 9, wherein the first side airbag is deployed and inflated such that the pressure of the first side airbag becomes a predetermined first pressure, and the second and third side airbags are deployed and inflated such that the pressure of the second and third side airbags becomes a predetermined second pressure, the second pressure being higher than the first pressure.

11. The side airbag apparatus according to claim 1, wherein the first side airbag is deployed and inflated to correspond also to the chest of the occupant.

12. The side airbag apparatus according to claim 1, wherein the first and second side airbags are coupled to each other, a first inflation chamber is defined in the first side airbag, a second inflation chamber is defined in the second side airbag, the first and second inflation chambers are connected with each other by a vent hole, wherein the side airbag apparatus further comprises a common inflator that deploys and inflates the first and second side airbag.

13. The side airbag apparatus according to claim 12, wherein a module that incorporates the inflator and the first and second airbags before being deployed and inflated is accommodated in a side door of the vehicle.

14. The side airbag apparatus according to claim 12, wherein the first side airbag is deployed and inflated such that the pressure of the first inflation chamber becomes a predetermined first pressure, and the second side airbag is deployed and inflated such that the pressure of the second inflation chamber becomes a predetermined second pressure, the second pressure being higher than the first pressure.

15. A side airbag apparatus mounted on a vehicle having a body and a seat on which an occupant is seated, wherein the seat includes a seat section and a backrest section, a passenger compartment is defined in the body, the apparatus comprising:
a first side airbag, wherein the first side airbag is deployed and inflated between the occupant and a sidewall of the passenger compartment to correspond to a body part of the occupant that includes at least a shoulder; and
a second side airbag, wherein the second side airbag is deployed and inflated between the first side airbag and the sidewall of the passenger compartment or between the first side airbag and the occupant to correspond at least to the shoulder.

16. The side airbag apparatus according to claim 15, wherein the first side airbag is deployed and inflated such that the pressure of the first side airbag becomes a predetermined first pressure, and the second side airbag is deployed and inflated such that the pressure of the second side airbag becomes a predetermined second pressure, the second pressure being higher than the first pressure.

17. The side airbag apparatus according to claim 15, wherein the first side airbag is deployed and inflated to correspond also to a lumbar region of the occupant.

18. A side airbag apparatus mounted on a vehicle having a body and a seat on which an occupant is seated, wherein the seat includes a seat section and a backrest section, a passenger compartment is defined in the body, the apparatus comprising:
a side airbag that is deployed and inflated between the occupant and a sidewall of the passenger compartment, wherein the airbag includes a first inflation chamber and a second inflation chamber, wherein the first inflation chamber corresponds to a body part of the occupant that includes at least a lumbar region, and the second inflation chamber corresponds at least to the lumbar region between the first inflation chamber and the sidewall of the passenger compartment or between the first inflation chamber and the occupant.

19. The side airbag apparatus according to claim 18, wherein the side airbag is deployed and inflated such that the pressure of the first inflation chamber becomes a predetermined first pressure, and the pressure of the second inflation chamber becomes a predetermined second pressure, the second pressure being higher than the first pressure.
